(19) United States
(12) Patent Application Publication
(10) Pub. No.: US 2025/0117419 A1
(43) Pub. Date: Apr. 10, 2025

(54) USER-SPECIFIC SYSTEM PROMPTS FOR LANGUAGE GENERATION

(71) Applicant: Insight Direct USA, Inc., Chandler, AZ (US)

(72) Inventors: David McCurdy, Centennial, CO (US); Jason Rader, Jacksonville, FL (US)

(21) Appl. No.: 18/911,868

(22) Filed: Oct. 10, 2024

Related U.S. Application Data
(60) Provisional application No. 63/543,456, filed on Oct. 10, 2023.

(51) Int. Cl. G06F 16/33; G06F 40/284

(52) U.S. Cl. CPC G06F 16/3344; G06F 40/284

(57) ABSTRACT

A method includes receiving, by a server and from a user device, a natural-language text prompt provided by the user to a chat application operating on the user device and at least one user preference for a user, the at least one user preference indicative of at least one preferred characteristic of natural-language outputs generated by a machine-learning language model based on user-provided natural-language text inputs. The method further includes, by the server, modifying a system prompt for the machine-learning language model with the received at least one user preference to generate a modified system prompt, providing the modified system prompt as an initial input to the machine-learning language model, providing the natural-language text prompt as an input to the machine-learning language model to generate a natural-language text output after providing the modified system prompt, and transmitting the natural-language text output to the user device.

### CROSS-REFERENCE TO RELATED APPLICATION

This application is a nonprovisional application claiming the benefit of U.S. provisional Ser. No. 63/543,456, filed on Oct. 10, 2023, entitled “USER-SPECIFIC SYSTEM PROMPTS FOR LANGUAGE GENERATION” by D. McCurdy and J. Rader.

### FIELD OF THE INVENTION

The present disclosure relates to user-specific language generation and, more particularly, systems and methods for creating user-specific system prompts for use with artificial intelligence models for language generation.

### BACKGROUND

Generative artificial intelligence (AI) language models, such as large language models and/or transformer models, are capable of dynamically generating content based on user prompts. Some language models are capable of generating human-like text and can be incorporated into text chat programs in order to mimic the experience of interacting with a human in a text chat. Language models can use a system prompt (sometimes referred to as a pre-prompt or internal prompt) to define roles and provide other instructions and/or constraints for language generation.

### SUMMARY

An example of a method includes receiving, by a server and from a user device, a natural-language text prompt provided by the user to a chat application operating on the user device and at least one user preference for a user, the at least one user preference indicative of at least one preferred characteristic of natural-language outputs generated by a machine-learning language model based on user-provided natural-language text inputs. The method further includes, by the server, modifying a system prompt for the machine-learning language model with the received at least one user preference to generate a modified system prompt, providing the modified system prompt as an initial input to the machine-learning language model, providing the natural-language text prompt as an input to the machine-learning language model to generate a natural-language text output after providing the modified system prompt, and transmitting the natural-language text output to the user device. The method yet further includes causing the chat application to communicate the natural-language text output to the user.

A further example of a method includes receiving, by a remote device and from a user device, a first natural-language text prompt provided by the user to a chat application operating on the user device and at least one user preference for a user indicative of at least one preferred characteristic of natural-language outputs generated by a machine-learning language model based on user-provided natural-language text inputs. The method further includes, by the remote device, modifying a system prompt for the machine-learning language model with the received at least one user preference to generate a first modified system prompt, providing the first modified system prompt as an initial input to the machine-learning language model, providing the first natural-language text prompt as an input to the machine-learning language model to generate a first natural-language text output, and transmitting the first natural-language text output to the user device. After the first natural-language text output is transmitted, the method includes causing the chat application to communicate the first natural-language text output to the user, updating the at least one user preference based on at least one input received by a user interface of the user device to generate at least one updated user preference, and receiving, by the remote device from the user device, a second natural-language text prompt provided by the user to a chat application operating on the user device and the at least updated one user preference for a user. The method further includes, by the remote device, modifying the first modified system prompt with the received at least updated one user preference to generate a second modified system prompt, providing the second modified system prompt as an initial input to the machine-learning language model, providing the second natural-language text prompt as an input to the machine-learning language model to generate a second natural-language text output, and transmitting the second natural-language text output to the user device. After transmitting the second natural-language text output, the method includes causing, by the user device, the chat application to communicate the second natural-language text output to the user.

An example of a system includes a user device comprising a first processor and at least one first memory storing at least one user preference indicative of at least one preferred characteristic of natural-language outputs generated by a machine-learning language model based on user-provided natural-language text inputs. The at least one first memory is encoded with first instructions that, when executed, cause the first processor to receive at least one input indicative of a natural-language text string and provide the natural-language text string as a natural-language text prompt to a chat application operating on the user device. The system further includes a remote device communicatively connected to the user device and comprising a processor and at least one second memory. The at least one second memory is encoded with second instructions that, when executed, cause the second processor to receive the natural language text prompt from the user device, receive the at least one user preference from the user device, modify a system prompt for the machine-learning language model based on the at least one user preference, provide the system prompt as an initial input to the machine-learning language model, provide the natural-language text prompt as an input to the machine-learning language model to generate a natural-language text output, and transmit the natural-language text output to the user device.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a schematic diagram of an example of a system for generating user-specific system prompts and further for generating natural language based on those user-specific system prompts.

FIG. 2 is a schematic diagram of another example of a system for generating user-specific system prompts and further for generating natural language based on those user-specific system prompts.

FIG. 3 is a schematic diagram of a further example of a system for generating user-specific system prompts and further for generating natural language based on those user-specific system prompts.

FIG. 4 is a flow diagram of an example of a method of generating user-specific system prompts and natural-language using those user-specific system prompts suitable for use by the systems of FIGS. 1-3.

While the above-identified figures set forth one or more examples of the present disclosure, other examples are also contemplated, as noted in the discussion. In all cases, this disclosure presents the invention by way of representation and not limitation. It should be understood that numerous other modifications and examples can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

The present disclosure relates to systems and methods for generating and using user-specific system prompts. The user-specific system prompts generated using the methods and systems herein can be used to improve natural-language responses generated by machine-learning language models in response to user-generated natural-language prompts. As will be explained in more detail subsequently, the use of user-specific system prompts increases the likelihood that machine-generated natural-language is relevant to a user, improving user experience and increasing user retention.

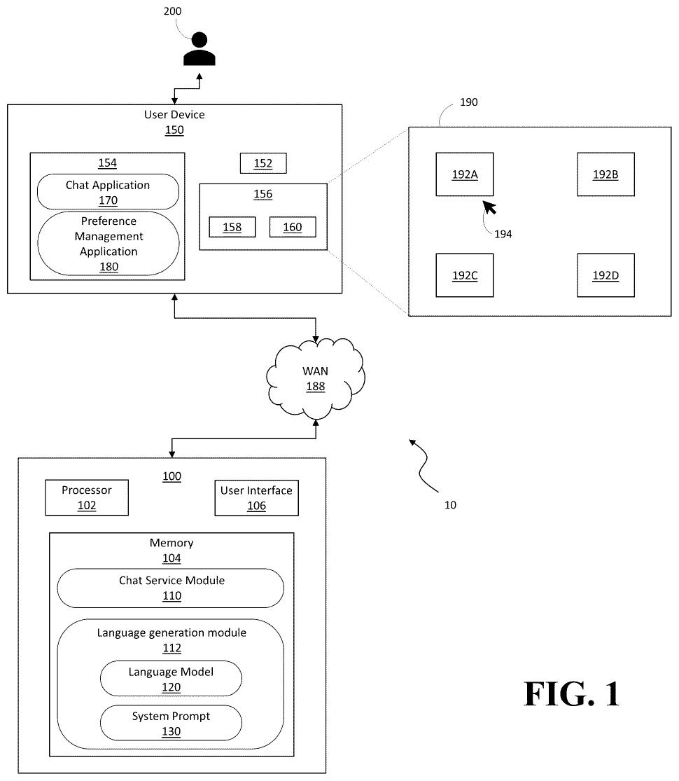

FIG. 1 is a schematic depiction of system 10, which is a system for generating natural-language responses to user-generated prompts. System 10 includes server 100, user device 150, and wide area network (WAN) 188. Server 100 includes processor 102, memory 104, and user interface 106. Memory 104 stores chat service module 110 and language generation module 112, which includes language model 120 and system prompt 130. User device 150 includes processor 152, memory 154, and user interface 156. User interface 156 optionally includes both input device 158 and output device 160. Memory 154 includes chat application 170 and preference management application 180. Preference management application 180 includes graphical user interface 190, which can be communicated to a user via user interface 156. Graphical user interface 190 includes graphical objects 192A-N, which are selectable using pointer 194. FIG. 1 also depicts user 200.

Server 100 operates a chat service that uses a machine-learning language model to generate natural-language responses to user-generated prompts. As will be explained in more detail subsequently, the natural-language responses generated by server 100 are based in part on user preferences stored to user device 150. User preference information stored to user device 150 is used to generate a user-specific system prompt, allowing the content of natural-language responses generated subsequently by a machine-learning language model to reflect user preferences. The system prompt can be changed or modified for each user accessing language-generation functionality of server 100 (e.g., for each instance of language-generation software operating on server 100), allowing for robust incorporation of user preferences in language generation.

Server 100 is connected to WAN 188 via one or more wired and/or wireless connections and is able to communicate with user device 150 via WAN 188. In some examples, server 100 can be referred to as a “remote device” and/or a “remotely-connected device.” Although server 100 is generally referred to herein as a server, server 100 can be any suitable network-connectable computing device for performing the functions of server 100 detailed herein.

Processor 102 can execute software, applications, and/or programs stored on memory 104. Examples of processor 102 can include one or more of a processor, a microprocessor, a controller, a digital signal processor (DSP), an application specific integrated circuit (ASIC), a field-programmable gate array (FPGA), or other equivalent discrete or integrated logic circuitry. Processor 102 can be entirely or partially mounted on one or more circuit boards.

Memory 104 is configured to store information and, in some examples, can be described as a computer-readable storage medium. Memory 104, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 104 is a temporary memory. As used herein, a temporary memory refers to a memory having a primary purpose that is not long-term storage. Memory 104, in some examples, is described as volatile memory. As used herein, a volatile memory refers to a memory that that the memory does not maintain stored contents when power to the memory 104 is turned off. Examples of volatile memories can include random access memories (RAM), dynamic random access memories (DRAM), static random access memories (SRAM), and other forms of volatile memories. In some examples, the memory is used to store program instructions for execution by the processor. The memory, in one example, is used by software or applications running on server 100 (e.g., by a computer-implemented machine-learning model) to temporarily store information during program execution.

Memory 104, in some examples, also includes one or more computer-readable storage media. Memory 104 can be configured to store larger amounts of information than volatile memory. Memory 104 can further be configured for long-term storage of information. In some examples, memory 104 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories.

User interface 106 is an input and/or output device and/or software interface, and enables an operator to control operation of and/or interact with software elements of server 100. For example, user interface 106 can be configured to receive inputs from an operator and/or provide outputs. User interface 106 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines.

In some examples, server 100 can operate an application programming interface (API) for facilitating communication between server 100 and other devices connected to WAN 188 as well as for allowing devices connected to WAN 188 to access functionality of server 100. A device connected to WAN 188, such as user device 150, can send a request to an API operated by server 100 to, for example, generate language using language model 120 and/or modify the content of system prompt 130.

User device 150 is an electronic device that a user (e.g., user 200) can use to access WAN 188 and functionality of server 100 (i.e., via WAN 188). User device 150 includes processor 152, memory 154, and user interface 156, which are substantially similar to processor 102, memory 104, and user interface 106, respectively, and the discussion herein of processor 102, memory 104, and user interface 106 is applicable to processor 152, memory 154, and user interface 156, respectively. User device 150 includes networking capability for sending and receiving data transmissions via WAN 188 and can be, for example, a personal computer or any other suitable electronic device for performing the functions of user device 150 detailed herein. Memory 154 stores software elements of chat application 170 and preference management application 180, which will be discussed in more detail subsequently and particularly with respect to the function of chat server module 110 of server 100.

User interface 156 optionally includes one or both of input device 158 and output device 160. Input device 158 is a device that a user (e.g., user 200) can use to provide inputs to the program(s) of user device 150. Input device 158 can be, for example, a touchscreen, a keyboard, a mouse, a joystick, etc. A user can use input device 158 to, for example, provide inputs to chat application 170 and preference management application 180. Output device 160 is a device for communicating outputs from the program(s) of user device 150 to a user (e.g., user 200). Output device 160 can include, for example, one or more of a display, a speaker, or any other suitable device for conveying outputs from the program(s) of user device 150.

WAN 188 is a wide-area network suitable for connecting servers (e.g., server 100) and other computing devices that are separated by greater geographic distances than the devices of a local network. WAN 188 includes network infrastructure for connecting devices separated by larger geographic distances. In at least some examples, WAN 188 is the Internet. Server 100 and user device 150 can communicate and transmit data via WAN 188.

Chat service module 110 is a software module of server 100 and includes one or more programs for running a chat service. The chat service operated by chat service module 110 is accessible by chat application 170 and enables users to receive machine-generated natural-language text replies to user-generated text prompts. Users are able to generate text prompts using chat application 170 and are able to use the functionality of chat application 170 to submit those text prompts to language module 112 using chat server module 110. Chat service module 110 runs services used and/or invoked by chat application 170 and, further, provides user-generated prompts to language module 112 and provides natural-language text replies generated by the program(s) of language module 112 to user device 150. Natural-language text replies generated by server 100 and transmitted to user device 150 in this manner can communicated to a user via chat application 170. For example, chat application 170 can cause output device 160 to display an indication, such as a text representation, of the natural-language text reply to allow a user (e.g., user 200) to read the reply and, in some examples, formulate a subsequent prompt.

While the service operated by chat service module 110 is generally referred to as a “chat service” herein, in some examples, the service operated by chat service 110 does not represent or relate user prompts and machine-generated replies as a natural-language text conversation. For example, chat service module 110 the chat service operated by chat service module 110 can be an API for accessing functionality of language generation module 112, such that chat application 170 functions as an interface, program, etc. for accessing calling functions of the API.

Language generation module 112 is another software module of server 100 and includes one or more programs for automated natural-language text generation. Language generation module includes language model 120 and system prompt 130. Language model 120 is a machine-learning language model trained to generate natural-language outputs (or tokenized representations thereof) from natural-language inputs (or tokenized representations thereof). In some examples, language model 120 can include one or more programs for converting natural-language inputs into numeric representations and for converting numeric representations of text information into natural-language text. For example, language generation module 112 can include a tokenization algorithm for generating tokens representative of text (e.g., encoding user inputs) and for generating natural-language text based on token information (e.g., decoding machine-generated tokens). Language model 120 can be, for example, a large language model and/or a transformer model.

In some examples, language generation module 112 can use a context injection approach to reduce hallucinations and/or fabrications in the outputs of language model 120. For example, language generation module 112 can perform retrieval augmented generation by retrieving database information and supplementing or otherwise modifying user prompts with some or all of the retrieved database information. The database(s) used by language generation module 112 can include, for example, a structured database, a semi-structured database, and/or a vector database, among other options.

System prompt 130 is natural-language text and/or a tokenized representation of natural-language text (i.e., one or more tokens representative of natural-language text) and provides instructions to language model 120 for generating natural-language responses to user-generated prompt text. System prompt 130 can be stored as, for example, a natural-language text string, an encoded text string (e.g., encoded as one or more tokens), or any other suitable format. System prompt 130 is generally referred to herein as a “system prompt,” but in other examples system prompt 130 can be referred to as a “pre-prompt” or “internal prompt.” Language generation module includes one or more programs that provide system prompt 130 to language model 120 prior to providing user prompts. The process of providing system prompt 130 to language model 120 is generally referred to herein as “system prompting,” but in other examples can be referred to as “pre-prompting” or “internal prompting.” In some examples, server 100 can store a default or standard system prompt 130 that can be modified by user device 150 and/or server 100 to incorporate user preference information.

Chat application 170 is a software application of user device 150 for receiving user prompts, providing those prompts to server 100, receiving responses from server 100, and communicating those responses to the user (e.g., user 200). Chat application 170 can be, in some examples, a web browser for accessing a web application hosted by server 100 that uses the functionality of chat service module 110. Additionally and/or alternatively, chat application 170 can be a specialized software application for interacting with chat service module 110 of server 100. Chat application 170 can be selectively operated by user device 150. For example, a user can provide one or more inputs to user device 150 to cause user device 150 to begin operating chat application 170. A user can provide user prompts by, for example, typing a natural-language phrase or sentence using a keyboard or a similar input device.

In some examples, chat application 170 can include a graphical user interface including one or more selectable graphical elements, such as one or more clickable elements and/or graphical buttons, representative of a natural-language text phrases that can be used as prompts for language model 120. A user can provide prompts to chat application 170 by interacting with the graphical elements of chat application 170 to select the natural-language text phrase(s) the user wants to use as an input to or prompt for language generation. Chat application 170 can then transmit the selected natural-language text phrase(s) to server 100 as the prompt for language generation by language model 120.

In some examples, chat application 170 can include a graphical user interface that displays a chat history between the user and server 100, such that a user can view previous user-submitted prompts and machine-generated replies created by server 100. Chat application 170 can display prior text replies as, for example, a conversation history or in any other suitable format. In some examples, chat 170 can also display only the most-recent language generated by server 100.

Preference management application 180 is a software application of user device 150 for managing user preferences and for creating system prompt or pre-prompt information that can be used to modify system prompt 180 to incorporate user preferences. Preference management application 180 manages and stores (e.g., to memory 154 and/or memory 104) user preferences for use in system prompt 130. Preference management application 180 can store user preferences as, for example, one or more text strings that can be provided to server 100 to be used as a system prompt for subsequent natural-language generation by language model 120 for the user. Additionally and/or alternatively, preference management application 180 can store user preferences as encoded text that can be provided to server 100 to be used as a system prompt. In these examples, user device 150 can optionally include an encoding algorithm (e.g., a tokenizing algorithm) suitable for generating encoded text usable by language model 120 (i.e., of the type of encoded text on which language model 120 was trained). In at least some examples, preference management application 180 is a software plugin or extension for a web browser.

A user can interact with software elements of preference management application 180 to define preferences in the outputs of language generation. Preference management application 180 can store those user preferences to user system 150 to be used to modify system prompt 130 or to identify information used to modify system prompt 130. System prompt 130 can be modified by, for example, adding additional text and/or encoded text information (e.g., tokenized text) stored by preference management application 180 to the existing system prompt. Additionally and/or alternatively, system prompt 130 can be modified by replacing some or all of the content of system prompt 130 with a system prompt created by preference management application 180 that includes user preferences.

In further examples, preference management application 180 can store user preferences to server 100 and/or another device connected to WAN 188. Preference management application 180 can, for example, retrieve user-preference information from another device connected to WAN 190 and can provide that user-preference information to server 100. Preference management application 180 can generate a user-specific system prompt from the user-preference information and can provide that user-specific system prompt to server 100 (i.e., to be used as or to modify system prompt 130).

Additionally and/or alternatively, preference management application 180 can transmit user-preferences to server 100 and/or can transmit a user-specific system prompt to server 100. Server 100 can then modify system prompt 130 according to the received user preferences and/or user-specific system prompt (e.g., by replacing the existing system prompt 130 with the user-specific system prompt) when server 100, for example, receives a user prompt from the user and/or when server 100 authenticates user access to language generation module 112 (e.g., based on user account credentials). Server 100 can be configured to, for example, retrieve a user's system prompt and/or user preference when server 100 based on a user identifier (e.g., a username, account number, etc.) included in a request from a user device (e.g., user device 150).

In some examples, user device 150 can issue one or more commands to server 100 (e.g., via an API operated by server 100) to modify system prompt 130 with user preferences. For example, preference management application 180 can be configured to cause server 100 to modify system prompt 130. Preference management application can be configured to detect that a user is operating chat application 170 (e.g., that the user has opened chat application 170 or otherwise caused user device 150 to operate chat application 170) and to automatically send one or more commands to server 100 to cause server 100 to modify system prompt 130. Additionally and/or alternatively, chat application 170 can automatically retrieve user preference information from preference management application 180 when a user is using chat application 170 and cause server 100 to update system prompt 130 based on the retrieved user preferences.

In other examples, server 100 can issue one or more commands to user device 150 to retrieve user preferences form preference management application 180. For example, server 100 can automatically request user preferences to modify system prompt 130 when server 100 receives a request to generate natural-language text (i.e., based on a user prompt).

Preference management application 180 can be configured to solicit (i.e., from a user) and store (e.g., to memory 154 and/or memory 104) any suitable information describing user preferences for the outputs of language model 120. For example, the user preference(s) managed by preference management application 180 can include user membership information, user subscription information (e.g., to a subscription service), preferred vendor information, and/or advertisement preference information, among other options. In some examples, the user preference(s) managed by preference management application can also include suitable data sources by context injection (e.g., retrieval augmented generation) by language generation module 112.

Graphical user interface 190 is an optional element of user device 150 and is graphical user interface for defining user preferences and is operated by the program(s) of preference management application 180. Graphical user interface 190 can be displayed by, for example, user interface 156 (e.g., output device 160) of user device 150. Graphical user interface 190 includes graphical objects 192A-N that a user can use to interact with preference management application 180 and to define user preferences. A user can control pointer 194 via, for example, input device 160 to interact with graphical objects 192A-N to define user preferences. Graphical objects 192A-N can be, for example, one or more checkboxes that a user can select to define user preferences for preference management application 180. In other examples, a user can input one or more text strings defining user preferences. Preference management application 180 can store the text string as user preference information for the user and/or can extract relevant text from the text string and store the extracted text as user preference information for the user. For example, preference management application 180 can extract one or more keywords and/or can use a natural language processing algorithm to identify and extract relevant information from the text string (e.g., intent and/or entity information).

Advantageously, system 10 enables user preference information to be used to dynamically modify system prompt 130 of server 100 with a custom, user-specific system prompt. The user-specific system prompts disclosed herein improve the quality of language generation performed by language model 120 by reducing the likelihood that an output of language model 120 is irrelevant to or unwanted by a particular user. For example, if a user prompt inquires for recommendations for a particular type of product and if the user preferences stored by preference management application 180 define a range of preferred vendors (i.e., preferred by the user) for that type of product, providing a user-specific system prompt defining those vender preferences can decrease the likelihood that an output of language model 120 includes a recommendation for a non-preferred vendor, thereby improving user satisfaction with the output of language model 120. Similarly, if a user prompt inquires for possible service offerings from vendors, some of which offer memberships with various benefits (e.g., a reward program, such as a frequent flyer program of an airline), and preference management application 180 stores user membership information, a system prompt including that membership information can increase the likelihood that an output of language model 120 suggests or recommends a vendor having a membership program) in which the user is enrolled, thereby improving user satisfaction with the output of language model 120. System 10 can be used to record and use a wide variety of user preferences and the prior examples are merely illustrative examples of advantages available through the use of system 10 and, in particular, the generation of custom system prompts using information collected by preference management application 180. As the prior examples illustrate, user-specific system prompts advantageously improve user satisfaction with the outputs of language model 120 by increasing the relevance of those outputs to individual users.

System prompt information can be customized for each user accessing the functionality of server 100. In examples where server 100 processes language generation requests for multiple users and operates multiple instances of language generation module 112 and/or chat service module 110, each instance can include a custom system prompt 130.

Further, the use of graphical elements of to define user preferences in preference management application 180 increases ease of use and thereby confers further advantages to examples of system 10 including graphical user interface 190 or a similar graphical user interface.

As described previously, preference management application 180 can also pre-encode system prompt information provided to server 100 to modify system prompt 130. Advantageously, this can reduce costs associated with accessing and/or operating server 100 by performing the compute tasks related to text encoding (e.g., tokenization) on user device 150 rather than server 100. Similarly, in some examples, preference management application 180 can be configured to optimize user-specific system prompts to reduce the length of the system prompt by, for example, removing filler words and/or performing natural language processing (e.g., via a natural language processing algorithm) to extract relevant intent and/or entity information from the user preference information collected by preference management application 180. Advantageously, reducing the length of the system prompt can reduce costs associated with operating and/or accessing language model 120 (e.g., by reducing the token length of the system prompt). In examples where language model 120 has a finite context window (e.g., is token-limited) such that language model 120 has a maximum length of text or tokens that can be used as an input for language generation, can be used to increase the total number of characters or tokens available for user prompts.

FIG. 1 depicts only one user device (i.e., user device 150) for illustrative convenience and for clarity, but in other examples, system 10 can include any number of user devices. System 10 can, for example, include multiple analogous user devices serving parallel functions, e.g. at different locations and/or for different users. Additionally or alternatively, functions of user device 150 (and any analogous user devices) can be distributed across multiple separate hardware devices accessible locally and/or via WAN 188. Similarly, while server 100 is depicted as a single device in FIG. 1, in other examples, server 100 can include multiple devices (e.g., multiple servers) configured to perform the functions of server 100.

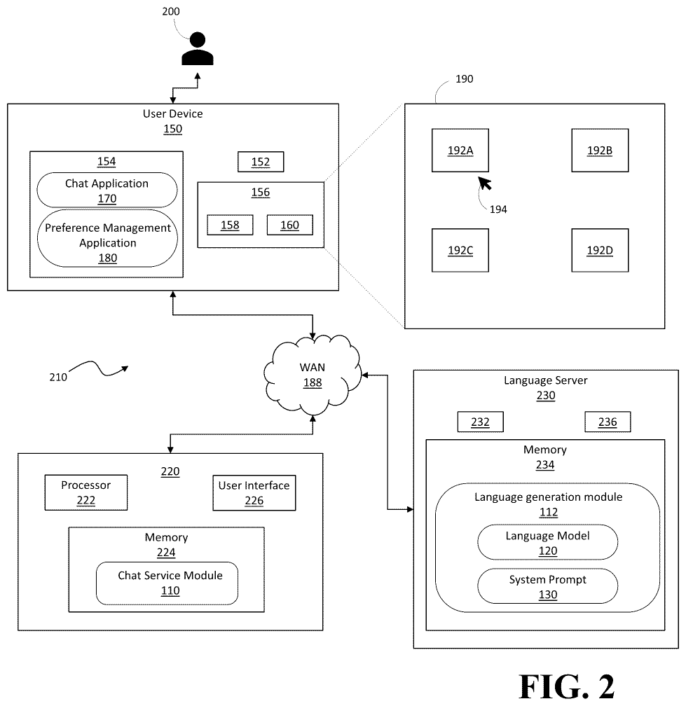

FIG. 2 is another example of a schematic depiction of system 210, which is another system for generating natural-language responses to user-generated prompts. System 210 is substantially similar to system 10, but also includes chat server 220 and language server 230 instead of server 100. Chat server 220 includes processor 222, memory 224, and user interface 226, which are substantially similar to processor 102, memory 104, and user interface 106, respectively, and the discussion herein of processor 102, memory 104, and user interface 106 is applicable to processor 222, memory 224, and user interface 226, respectively. Language server 230 includes processor 232, memory 234, and user interface 236, which are substantially similar to processor 102, memory 104, and user interface 106, respectively, and the discussion herein of processor 102, memory 104, and user interface 106 is applicable to processor 232, memory 234, and user interface 236, respectively. In system 210, memory 224 stores chat service module 110 and memory 234 stores language generation module 112.

In system 210, chat server 220 includes chat service module 110 and operates the chat service accessed by chat application 170. Language server 230 includes language generation module 112 and performs language generation to create natural-language responses for chat server 220. Chat server 220 is configured to access the language generation functionality of language server 230 and can send one or more commands to language server 230 (e.g., one or more API calls) to cause language server 230 to generate natural-language responses to user prompts. Chat server 220 can also issue one or more commands to language server 230 to modify system prompt 130. Chat server 220 can request user preference information from user device 150 and/or user device 150 can transmit user preference information when a user sends a prompt and/or when a user accesses chat application 170. Each of chat server 220 and language server 230 can operate an API exposed to allow other devices (e.g., user device 150 and chat server 220, respectively) to access the functionality of chat server 220 and/or language server 230.

In operation of system 210, user device 150 sends user preferences and user-generated natural-language prompts to chat server 220. Chat server 220 accesses functionality of language server 230 to modify system prompt 130 and generate a user-specific natural-language response to the user prompt. Chat server 220 then provides the generated natural-language response to user device 150.

System 210 confers several advantages. System 210 confers the advantages of system 10 discussed previously. Further, system 210 is able to confer the advantages of system 10 in situations where it is advantageous for chat server 220 and language server 230 to be separate devices and, further, in examples where those separate devices are separated by large geographic distances. As a specific example, system 210 enables the advantages of system 10 where the entity operating the chat service (i.e., operating chat server 220) is a different entity than the entity operating language server 230. Chat server 220 can receive preferences form preference management application 180 and use those preferences to modify the system prompt of a third-party language server 230 to perform user-specific language generation according to the present disclosure.

FIG. 2 depicts only one user device (i.e., user device 150) for illustrative convenience and for clarity, but in other examples, system 210 can include any number of user devices. Similarly, while chat server 220 and language server 230 are each depicted as a single device in FIG. 2, in other examples, each of chat server 220 and language server 230 can include multiple devices (e.g., multiple servers) configured to perform the functions of server 100.

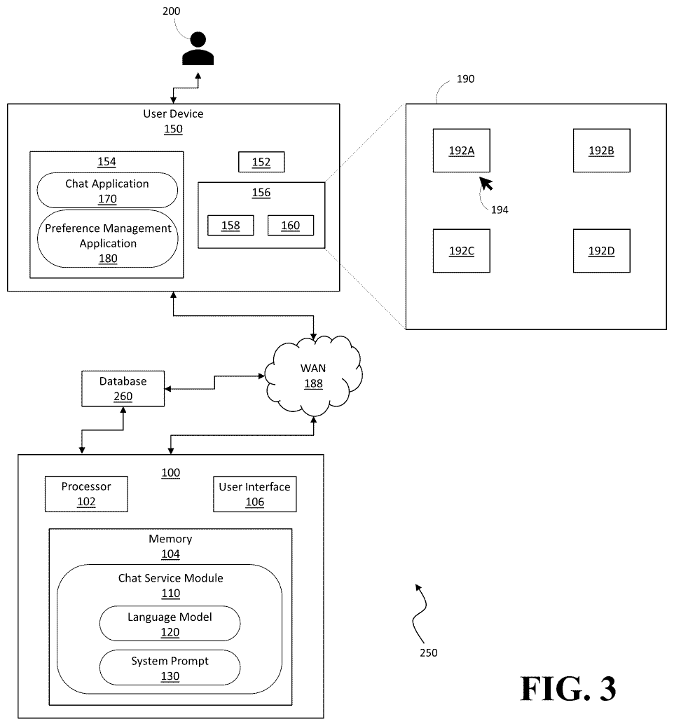

FIG. 3 is a schematic depiction of system 250, which is yet a further example of a system for generating natural-language responses to user-generated prompts. System 250 is substantially similar to system 10, but also includes database 260. Database 260 is an electronic database that is directly connected to server 100 and/or is connected to server 100 via a local network. Database 260 includes machine-readable data storage capable of retrievably housing stored data, such as database or application data. In some examples, database 260 includes long-term non-volatile storage media, such as magnetic hard discs, optical discs, flash memories and other forms of solid-state memory, or forms of electrically programmable memories (EPROM) or electrically erasable and programmable (EEPROM) memories. Database 260 can include a processor, at least one memory, and a user interface that are substantially similar to processor 102, memory 104, and user interface 106 of server 100. Database 260 can be a structured database (e.g., a table or relational database), a semi-structured database (e.g., a hierarchical and/or nested database), or a vector database, among other options. The program(s) of language generation module 112 can query database 260 with a user prompt to perform context injection (e.g., retrieval augmented generation). Database 260 can be queried with all or part of the user prompt. For example, if database 260 is a vector database, user prompts can be vectorized and used to query the vector database. As an additional example, server 100 can use an algorithm, such as a natural language processing algorithm, to extract one or more relevant words and/or phrases from a user prompt and use the extracted word(s) and/or phrase(s) to query database 260. The aforementioned examples are illustrative and non-limiting, and other methods of querying database 260 are possible.

FIG. 3 depicts only one user device (i.e., user device 150) for illustrative convenience and for clarity, but in other examples, system 10 can include any number of user devices. Similarly, while server 100 is depicted as a single device in FIG. 3, in other examples, server 100 can include multiple devices (e.g., multiple servers) configured to perform the functions of server 100. In some examples, system 250 can include two separate devices to perform the chat and language generation functions, respectively, of server 100, as described previously with respect to FIG. 2. FIG. 3 depicts database 260 as communicatively connected to both server 100 and WAN 188 for illustrative clarity and explanatory convenience, but in other examples, database 260 can be connected to only one of server 100 and WAN 188. Where database 260 is only connected to WAN 188, server 100 and/or any other suitable device can query database 260 via data transmissions sent through WAN 188. FIG. 3 also depicts only one database 260 for illustrative convenience and clarity, but in other examples, system 10 can include any suitable number of databases connected to server 100 in any suitable manner.

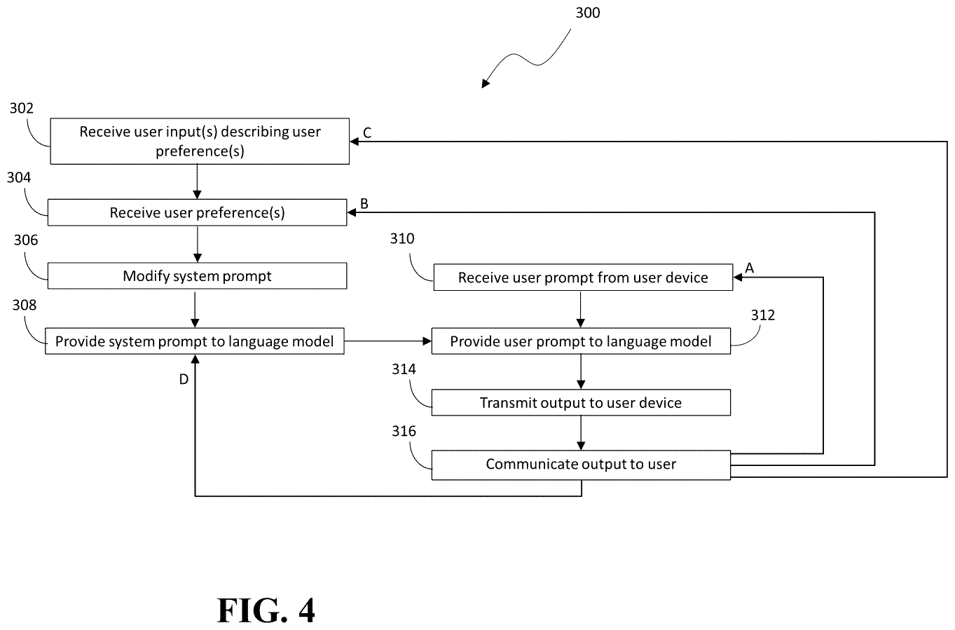

FIG. 4 is a flow diagram of method 300, which is a method of generating and using user-specific system prompts suitable for use with systems 10, 210, 250 (FIGS. 1-3). Method 300 includes steps 302-316 of receiving a user input(s) describing a user preference(s) (step 302), receiving user preference(s) (step 304), modifying a system prompt (step 306), providing the system prompt to a language model (step 308), receiving a user prompt from the user device (step 310), providing the user prompt to the language model (step 312), transmitting the output to the user device (step 314), and communicating the output to the user (step 316). Method 300 is generally described herein with respect to the devices of system 10 (and the same, functionally equivalent, and/or similar devices of systems 210, 250), but method 300 can be performed using any suitable system to confer advantages related to user-specific system prompts. FIG. 4 also includes arrows A-D, which represent different iteration options for method 300.

In step 302, server 100 receives a user input describing a user preference. The input can be submitted via one or more input devices (e.g., input device 158) and/or user interface devices (e.g., user interface 156) of a user device and can be used by preference management application 180 to define user preferences in subsequent steps of method 300. The input(s) can be any suitable input(s) and, in some examples, can target one or more graphical objects (e.g., of graphical objects 192A-N) of a graphical user interface (e.g., graphical user interface 190). The graphical objects can be, for example, one or more checkboxes that are selectable by the user (e.g., by using a pointer or cursor controlled by an input device). The input device can be, for example, a mouse, a keyboard, and/or a touchscreen, among other options. In some examples, the input can be a user-provided a natural-language text string detailing and/or describing the user's preferences. Any number of inputs can be received in step 302 defining any number of user preferences.

The user preference can be stored to the user device and/or to server 100 (or another suitable device connected to WAN 188) for further use with method 300 and/or with additional iterations of method 300. The user preference can be stored by, for example, storing the data representative of the user preference to a memory of the user device (e.g., memory 104, memory 154, etc.). The user preference can be stored as a natural-language representation of the user preference. Additionally and/or alternatively, the user preference can be pre-encoded for use by a language model in subsequent steps of method 300 and the encoded form the user preference can be stored in step 304. The user preference can be encoded as, for example, one or more tokens representative of the user preference. Any number of user preferences can be stored according to the number of user preferences defined in step 302. In some examples, the user preference information can be organized and/or arranged in a format suitable as a system prompt for a natural-language model, and can be stored in that format and/or as an encoding representative thereof. User preference information can also be optionally stored temporarily to a memory of the user device and then subsequently transmitted to server 100 to be stored for use with further steps of method 300.

Step 302 is optional and is performed in examples of method 300 where it is advantageous for a user to define the user's preferences. In some examples and particularly where user preferences are unknown, it may be suitable for a user to define the user's preferences. In other examples, such as where the user's preferences are known and/or where another entity (e.g., an entity operating the server that runs a chat service and/or language generation) knows of or prefers to define user preferences, step 302 can be omitted and user preferences can be defined by the non-user entity.

In step 304, server 100 receives user preference information. Server 100 can receive user preference information from, for example, from the user device (e.g., user device 150) and/or by recalling that user preference information from memory 104 of server 100. Server 100 can receive user preference information by recalling user preference information from memory 104 in examples where server 100 stores user preference information previously provided to a user device and transmitted to server 100. In these examples, method 300 can optionally omit step 302 and can begin from step 304. Server 100 receives user preference information as natural-language text (including as an electronic indication thereof) and/or as an encoding representative of the natural-language text (including as an electronic indication thereof). The preferences can, in some examples, be received as a pre-generated system prompt descriptive of and/or reflective of user preference information. The user preference(s) are stored to the user device by the instance of preference management application 180 running on the user device and can include the user preferences received and stored in step 302. In some examples, additional user preference information received outside of step 302 (e.g., provider-supplied user preferences) can be received in addition to or alternatively to the user preferences received in step 302. Advantageously, receiving user preference(s) as encodings (e.g., tokens) in step 306 reduces computational load on server 100 associated with encoding (e.g., tokenizing) natural-language information representative of the user preference(s).

User device 150 and/or server 100 can, for example, generate natural language representative of user preference information based on inputs from a user to a graphical user interface operated by user device 150 (e.g., graphical user interface 190). User device and/or server 100 can be configured to automatedly and/or automatically generate natural-language and/or an encoding representative thereof that corresponds to the preferences indicated by the user in the graphical user interface. Additionally and/or alternatively, a user can select, indicate, describe, etc. user preference information in natural language provided to user device 150 (e.g., via a user interface device, such as a keyboard or touchscreen). User device 150 and/or server 100 can be configured to remove filler words from the user-provided natural language using, for example, one or more natural language processing models configured to identify and/or remove filler language and/or a machine-learning language model to generate a natural-language summary of the user-provided natural language.

In step 306, server 100 modifies system prompt 130 provided to language model 120 prior to language generation based on the user preference information received in step 304. System prompt 130 can be modified by, for example, augmenting a pre-existing system prompt (e.g., a default system prompt) with user preference information received in step 304. Additionally and/or alternatively, the system prompt can be modified by replacing some or all of the pre-existing system prompt (e.g., a default system prompt) with new system prompt information based on the user preference information received in step 304.

In step 308, the system prompt modified in step 306 (e.g., system prompt 130) is provided to language model 120. The system prompt can be provided as an initial set of instructions and/or as an initial query to language model 120. In at least some examples, language model 120 does not generate natural language in response to the system prompt provided in step 308. In other examples, language model 120 can generate natural language responsive to the system prompt, but that natural language is not provided to the user via chat application 170.

In step 310, server 100 receives a user prompt from the user device, such as user device 150. The prompt is natural-language text (e.g., a text string) that includes a natural-language representation of one or more user questions and/or statements for prompting natural-language generation by language model 130. A user can enter a message composed at least partially of the question(s) and/or statement(s) into a chat application configured to interact with and use functionality of server 100 (e.g., chat application 170), and the chat application can provide the message to server 100. The received message can be used as the prompt received in step 310. In some examples, server 100 can remove portions of the user message, such as extraneous filler words, and use the resulting natural-language text as the prompt.

Steps 304-308 can be performed by server 100, user device 150, and/or a combination thereof. Server 100 can, for example, retrieve user preference information in step 304 from the user device when server 100 receives the user prompt in step 310. Server 100 can send one or more requests to user device 150 in response to receiving a user prompt and can receive user preference information from user device 150 in response to the request(s). In examples where the user device authenticates user access to language model 120 prior to generating a natural-language output based on a user prompt (e.g., during or subsequent to a user log-on), server 100 can also request user preference information from the user device during access authentication. One or more programs of server 100 can then modify system prompt 130 based on the provided user preference(s) in step 306.

Additionally and/or alternatively, user device 150 can provide user preference information to server 100 in step 304. User device 150 can be configured to, for example, automatically transmit user device information to server 100 (e.g., via WAN 188) when a user prompt is transmitted to server 100 and/or when user device 150 is operating chat application 170. As a specific example, preference management application 180 can be configured to automatically send user preference information when preference management application 180 or another program of user device 150 detects that chat application 170 is operating on user device 150. As a further example, chat application 170 can be configured to automatically retrieve user preference information from memory 104 and to cause user device 150 transmit that preference information to server 100 when a user is operating chat application 170 and/or submits a prompt for natural language generation using chat application 170. In some examples, user device 150 can also send one or more commands, such as one or more commands for an API operated by server 100, that instruct server 100 to modify system prompt 130 according to the transmitted user preference information.

In step 312, the user prompt received in step 310 is provided as an input to language model 120. The user prompt can be provided as natural language and/or as an encoding representative thereof. In examples where the user prompt is provided as an encoding representative of natural language (e.g., as one or more tokens), server 100 and/or user device 150 can generate the encoding based on the natural language of the user prompt. Language model 120 generates a natural-language output and/or an encoding representative thereof based on the user prompt. The natural-language output can be stored to, for example, memory 104 and used with further steps of method 300. In some examples, server 100 can query one or more databases (e.g., database 260) based on the user prompt and/or the user's preferences as part of a context-injection approach to language generation (e.g., retrieval-augmented generation). Steps 308 and 310 can be performed in any order, but both steps 308 and 310 are performed prior to step 312 of method 300. For example, the user prompt can be received in step 310 following step 306 and prior to step 308, and/or prior to step 306 (and therefore also prior to step 308). As an additional example, step 310 can be performed subsequent to step 308.

In step 314, the output generated in step 312 is transmitted from server 100 to user device 150. The output can be transmitted as, for example, one or more packets via WAN 188. Server 100 can be configured to automatically transmit the output to user device 150 after step 312.

In step 316, user device 150 communicates the output generated in step 314 to the user operating the user device. User device 150 can provide an indication of the output to the user, such as displayed text of the natural-language output, spoken audio of the natural-language output, etc.

After step 316, method 300 can proceed via any of arrows A-D to steps 302, 304, 308, and 310. Method 300 can proceed to step 310 (i.e., via arrow A) where a user's preference information does not need to be updated prior to further natural-language generation for that user. Method 300 can proceed to step 302 (i.e., via arrow B) in examples where a user modifies the user's preference information stored by preference management application 180 after reviewing an output from language model 120 communicated in step 318. Method 300 can proceed to step 304 (e.g., via arrow C) in examples where the user preference information is no longer stored by server 100 (e.g., due to a server restart, etc.) and/or the language model, system, and/or server performing language generation is changed following an iteration of step 318. For example, one iteration of steps 306-318 can be performed using a first language model by providing user preferences and modifying a system prompt stored by the system and/or server operating the first language model, and an additional iteration of step 306-316 can be performed using a second language model by again providing user preferences and modifying the system prompt used by the system and/or server operating the second language model. Method 300 can proceed to step 308 (e.g., via arrow D) in examples where the user-specific system prompt will no longer be included in a language model's context window to generate language based on a subsequently-provided user prompt. In these examples, method 300 can proceed to step 308 to provide another copy of the system prompt to the language model prior to providing the new user prompt to the language model in step 312. Examples of method 300 that iterate according to arrow D can also include an additional iteration of step 310.

Method 300 provides several advantages. Method 300 provides a method of user-specific natural-language generation by a language model (e.g., a large language model and/or transformer model) based on a user-specific system prompt. As described previously, incorporating user preferences into a system prompt improves the relevance of outputs generated by a language model to the user and to the prompts submitted by the user. Improving user-relevance of the outputs of a language model can improve user experience when using the language model and can, accordingly, improve user retention of a service for accessing functionality of the language model. While method 300 has been described herein generally with respect to systems, 10, 210, 250, method 300 can be performed in any suitable system.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of automated pre-prompt generation based on user preferences, the method comprising:
receiving, by a server and from a user device, a natural-language text prompt provided by the user to a chat application operating on the user device;
receiving, by the server and from the user device, at least one user preference for a user, the at least one user preference indicative of at least one preferred characteristic of natural-language outputs generated by a machine-learning language model based on user-provided natural-language text inputs;
modifying, by the server, a system prompt for the machine-learning language model with the received at least one user preference to generate a modified system prompt;
providing, by the server, the modified system prompt as an initial input to the machine-learning language model;
providing, by the server and after providing the modified system prompt, the natural-language text prompt as an input to the machine-learning language model to generate a natural-language text output;
transmitting, by the server, the natural-language text output to the user device; and
causing, by the user device, the chat application to communicate the natural-language text output to the user.

2. The method of claim 1, and further comprising encoding, before receiving the at least one user preference, the at least one user preference to at least one memory of the user device based on at least one input received by a user interface of the user device, wherein receiving the at least one preference comprises retrieving the at one preference from the at least one memory.

3. The method of claim 2, wherein:
encoding the at least one user preference to the at least one memory comprises:
generating at least one token representative of the at least one user preference using a tokenizer algorithm configured to generate input tokens usable by the machine-learning language model; and
storing the at least one token to the at least one memory, and
retrieving the at least one user preference comprises retrieving the at least one token.

4. The method of claim 3, wherein:
generating the at least one token comprises generating the at least one token upon receiving the at least one input,
storing the at least one token to the at least one memory comprises storing the token upon generating the at least one token, and
retrieving the at least one token from the at least one memory comprises retrieving the at least one token after an inactive period, wherein:
the inactive period follows storing the at least one token, and
the chat application does not receive any user prompts during the inactive period.

5. The method of claim 2, and further comprising updating the at least one user preference, before receiving the at least one user preference, based on at least one additional input received by the user interface of the user device.

6. The method of claim 1, and further comprising:
receiving, by the chat application, the natural-language text prompt based on at least one input at the user device;
upon receiving the natural-language text prompt, causing, by the chat application, the user device to transmit the at least one user preference to the server and a command to the server to modify the system prompt based on the at least one user preference; and
upon transmitting the at least one user preference to the server, causing, by the chat application, the user device to transmit the natural-language text prompt to the server.

7. The method of claim 1, and further comprising requesting, by the server, the at least one user preference from the user device upon receiving the natural-language text prompt.

8. The method of claim 1, and further comprising:
causing the user device to begin operating the chat application;
detecting, by a preference management application operating on the user device, that the user device is operating the chat application, the preference management application configured to manage the at least one user preference; and
causing, by the preference management application, the user device to transmit to the server, upon detecting that the user device is operating the chat application:
the at least one user preference; and
a command to modify the system prompt based on the at least one user preference.

9. The method of claim 8, wherein the command is configured to invoke one or more functions of an application programming interface operated by the server to cause the server to modify the system prompt.

10. The method of claim 1, wherein the machine-learning language model is operated by a language server connected to the server by a wide area network, and wherein:
modifying the system prompt comprises transmitting, by the server, a first request to the language server including a first command to modify the system prompt; and
providing the natural-language text prompt as an input to the machine-learning language model comprises transmitting a second request to the language server including a second command to generate the natural-language text output based on the natural-language text prompt.

11. The method of claim 10, wherein the first command invokes at least one first function of an application programming interface operated by the language server to cause the language server to modify the system prompt, and the second command invokes at least one second function of the application programming interface to cause the server to generate the natural-language text output.

12. The method of claim 11, wherein:
modifying the system prompt comprises receiving, by the server, a command from the user device to modify the system prompt; and
transmitting, by the server, the request to the language server comprises transmitting the request in response to the command from the user device.

13. The method of claim 1, wherein the at least one user preference is at least one of a membership, a subscription, a preferred vendor, an advertisement preference, and a data source for context injection.

14. The method of claim 1, and further comprising:
displaying, by the user device, a graphical user interface of a preference management application configured to manage user preferences for natural language outputs from the machine-learning language model;
receiving, by the user device, at least one input from an input device electronically connected to the user device, the at least one input targeting one or more graphical objects of the graphical user interface;
generating, by the preference management application, the at least one user preference in response to the at least one input; and
storing, by the preference management application, the at least one user preference to at least one memory of the user device.

15. The method of claim 14, wherein the one or more graphical objects comprise one or more checkboxes and the at least one input comprises at least one selection of the one or more checkboxes.

16. The method of claim 14, wherein generating the at least one user preference comprises generating at least one natural-language word based on the at least one input.

17. The method of claim 1, and further comprising receiving, by the user device, at least one input from an input device electronically connected to the user device, the at least one input describing one or more natural-language words corresponding to the at least one user preference, and wherein receiving the at least one user preference comprises receiving an indication of the one or more natural-language words.

18. The method of claim 17, and further comprising removing at least one filler word from the one or more natural-language words prior to receiving the indication of the one or more natural-language words.

19. A method of automated pre-prompt generation based on user preferences, the method comprising:
receiving, by a remote device and from a user device, a first natural-language text prompt provided by the user to a chat application operating on the user device;
receiving, by the remote device and from the user device, at least one user preference for a user, the at least one user preference indicative of at least one preferred characteristic of natural-language outputs generated by a machine-learning language model based on user-provided natural-language text inputs;
modifying, by the remote device, a system prompt for the machine-learning language model with the received at least one user preference to generate a first modified system prompt;
providing, by the remote device, the first modified system prompt as an initial input to the machine-learning language model;
providing, by the remote device and after providing the first modified system prompt, the first natural-language text prompt as an input to the machine-learning language model to generate a first natural-language text output;
transmitting, by the remote device, the first natural-language text output to the user device;
causing, by the user device, the chat application to communicate the first natural-language text output to the user;
updating, after causing the chat application to communicate the first natural-language output, the at least one user preference based on at least one input received by a user interface of the user device to generate at least one updated user preference;
receiving, by the remote device and from the user device, a second natural-language text prompt provided by the user to a chat application operating on the user device;
receiving, by the remote device and from the user device, the at least updated one user preference for a user;
modifying, by the remote device, the first modified system prompt with the received at least updated one user preference to generate a second modified system prompt;
providing, by the remote device, the second modified system prompt as an initial input to the machine-learning language model;
providing, by the remote device and after providing the second modified system prompt, the second natural-language text prompt as an input to the machine-learning language model to generate a second natural-language text output;
transmitting, by the remote device, the second natural-language text output to the user device; and
causing, by the user device, the chat application to communicate the second natural-language text output to the user.

20. A system for language generation, the system comprising:
a user device comprising:
a first processor; and
at least one first memory storing at least one user preference indicative of at least one preferred characteristic of natural-language outputs generated by a machine-learning language model based on user-provided natural-language text inputs, the at least one first memory encoded with first instructions that, when executed, cause the first processor to:
receive at least one input indicative of a natural-language text string; and
provide the natural-language text string as a natural-language text prompt to a chat application operating on the user device; and
a remote device communicatively connected to the user device, the remote device comprising:
a second processor; and
at least one second memory encoded with second instructions that, when executed, cause the second processor to:
receive the natural language text prompt from the user device;
receive the at least one user preference from the user device;
modify a system prompt for the machine-learning language model based on the at least one user preference;
provide the system prompt as an initial input to the machine-learning language model;
provide, subsequent to providing the system prompt, the natural-language text prompt as an input to the machine-learning language model to generate a natural-language text output; and
transmit the natural-language text output to the user device.
